(19) United States
(12) Patent Application Publication
(10) Pub. No.: US 2009/0026876 A1
(43) Pub. Date: Jan. 29, 2009

(54) Hybrid construction electric machine

(75) Inventors: Donald Alfred Atkinson, South Australia (AU); Daphne Atkinson, South Australia (AU)

Correspondence Address: OSHA LIANG L.L.P., TWO HOUSTON CENTER, 909 FANNIN, SUITE 3500, HOUSTON, TX, 77010, US

(73) Assignee: Intelligent Electric Motor Solutions PTY LTD, Hindmarsh, South Australia (AU)

(21) Appl. No.: 10/583,215

(22) PCT Filed: Dec. 16, 2004
(86) PCT No.: PCT/AU04/01766

§ 371 Date: Jan. 22, 2008

(30) Foreign Application Priority Data
Dec. 18, 2003 (AU) 2003906990

(51) Int. Cl. H02K 1/02; H02K 15/02

(52) U.S. Cl. 310/259; 29/596

(57) ABSTRACT

An electric machine including at least one magnetically inducible structure (2), said structure comprising at least two magnetically inducible portions (3, 4), at least one said portion being of laminar construction (3) and at least another said portion being non-laminar in construction (4), the laminar portion having greater mechanical strength than the non-laminar portion.

### TECHNICAL FIELD

This invention relates to electric machines and in particular to brushless electric machines with salient pole stators.

### BACKGROUND ART

Electrical machines be these motors, generators or transformers currently conventionally use coils of electrically conductive wire wound around a magnetically inducible core to create or be affected by magnetic fields.

In order to reduce eddy current losses in a core, it is also conventional to laminate the core using a plurality of separate plates or laminations which are laid against one another with the alignment of each lamination being determined by the overall structure of the electric machine and where any magnetic fields induced therein are required to be directed. This required structure however which is to say wound coils and laminated cores currently determine the current conventional electric motor construction requirements.

I have discovered that there can be an alternative construction which I have found can provide alternative options for electric machine designers which does in at least some cases provide advantages over the current machines designed according to current techniques.

Other objects and advantages of the present invention will become apparent from the following description taken in connection with the accompanying drawings wherein by way of illustration and example an embodiment of the present invention is disclosed.

Laminations are used to provide an anisotropic core. Electrical steel, from which the laminations are traditionally made, has low electrical resistance. It cannot be employed in an isotropic form.

An alternative solution to the problem of eddy currents is the use of “bonded iron” or soft magnetic composite to form the core. This material is known by the trade name of “Somaloy” or “FM-CM”. This material has magnetic properties suitable for use as a coil core, combined with high electrical resistance. It allows an isotropic core to be constructed which does not suffer from the problem of excessive eddy currents.

However, in many electric machines, the stator serves more than electrical and magnetic purposes. It also provides the mechanical frame of the machine. The mechanical properties of bonded iron (strength TRS in the range 40-100 Mpa) are inferior to those of electrical steel. Further, mechanical fabrication of solid stators with complex internal profiles as may be required for optimum positioning of windings within the stator is expensive. Laminations can be cheaply pressed out in a great variety of shapes.

### DISCLOSURE OF THE INVENTION

Accordingly we have discovered that both types of core material can indeed be used jointly and this provides significant advantages. By having some of the structure being of laminate construction and some that is suitable for being a core but is of non laminar construction allows for complex shapes and efficiencies to be achieved that have not been previously thought to be possible.

In one form of this invention although this may not be the only or indeed the broadest form of this there is proposed an electric machine which includes at least one magnetically inducible structure, said structure comprising at least two magnetically inducible portions, at least one said portion being of laminar construction and at least another said portion being non-laminar in construction.

In the alternative there is provided an electric motor or generator having a stator and a rotor, characterised in that in at least the stator has at least one coil and a core that is magnetically inducible from said coil where the core has at least two parts where one of the parts is of laminar construction and provides a rugged support and a further part is of non laminar construction.

In preference, the laminar portion is arranged to be in a location where its more rugged mechanical strength is effective to protect the other less rugged non-laminar portion.

In preference the non-laminar portion is positioned so that it is protected by higher rugged construction laminar material.

In preference, the magnetically inducible structure is a stator of an electric machine.

A significant advantage of a hybrid stator with both laminated and non-laminated portions is that it combines the mechanical properties of a laminated stator with the ease of construction of a solid stator.

In preference the laminar portion is a frame of a stator of an electric machine typically a motor or generator.

In preference, the non-laminar portion is a pole piece of a stator of an electric machine.

In preference, a frame or back-iron of the machine is constructed from electrical steel.

In preference, pole pieces of the machine are constructed from bonded iron.

Electrical steel has low electrical resistance and thus is conventionally in a laminated construction when used as a magnetic core in order to reduce eddy currents. Bonded iron has high electrical resistance and can be used as a solid piece as a magnetic core.

In preference, each lamination of the frame is pressed in such a shape that, when assembled into the frame, the internal profile of the frame is non-circular in such a way as to maximise the amount of space available for a stator coil.

In preference the electric machine is an electrical motor.

In preference in the alternative the electric machine is an electrical generator.

In preference in the alternative the electric machine is an electrical transformer.

The invention in a further form may be said to reside in a method of constructing an electric machine which includes the steps where approximately annular laminations are pressed from magnetically inducible, mechanically strong material,

said laminations are assembled into a frame,
and pole pieces made from a magnetically-inducible material of high electrical resistance are attached to said frame.

For a better understanding of this invention it will now be described with reference to a preferred embodiment which shall be described herein with the assistance of the drawings wherein;

### BRIEF DESCRIPTION OF THE DRAWINGS

FIG. 1 is a perspective view of an electrical machine constructed according to a preferred embodiment of the present invention; and

FIG. 2 is plan view of the electrical machine of FIG. 1; and

FIG. 3 is a cross-section of the electrical machine of FIG. 2; and

FIG. 4 is a plan view of a lamination of the stator of the electrical machine of FIG. 1.

### BEST MODE FOR CARRYING OUT THE INVENTION

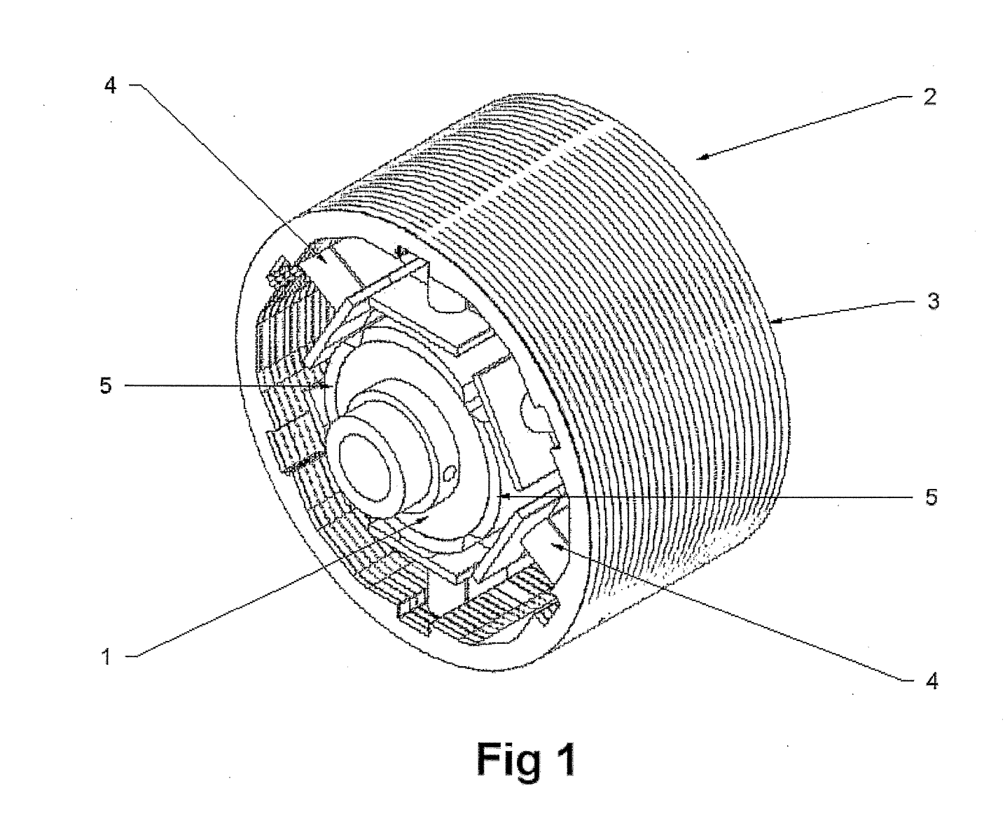

Now referring to the illustrations and in particular FIG. 1 which is a perspective view of an embodiment of the present invention. Illustrated is a brushless DC electric motor. There is a rotor 1 which has permanent magnetic pole pieces 5. The stator 2 consists of an outer approximately cylindrical frame 3 and a series of salient pole pieces 4. In the illustrated embodiment there are six pole pieces on the stator and four on the rotor. This 6-4 arrangement is common in the field, but many other combinations are possible. Coil windings, which will surround each stator pole piece, have been omitted from the drawing for clarity but are included in the embodiment.

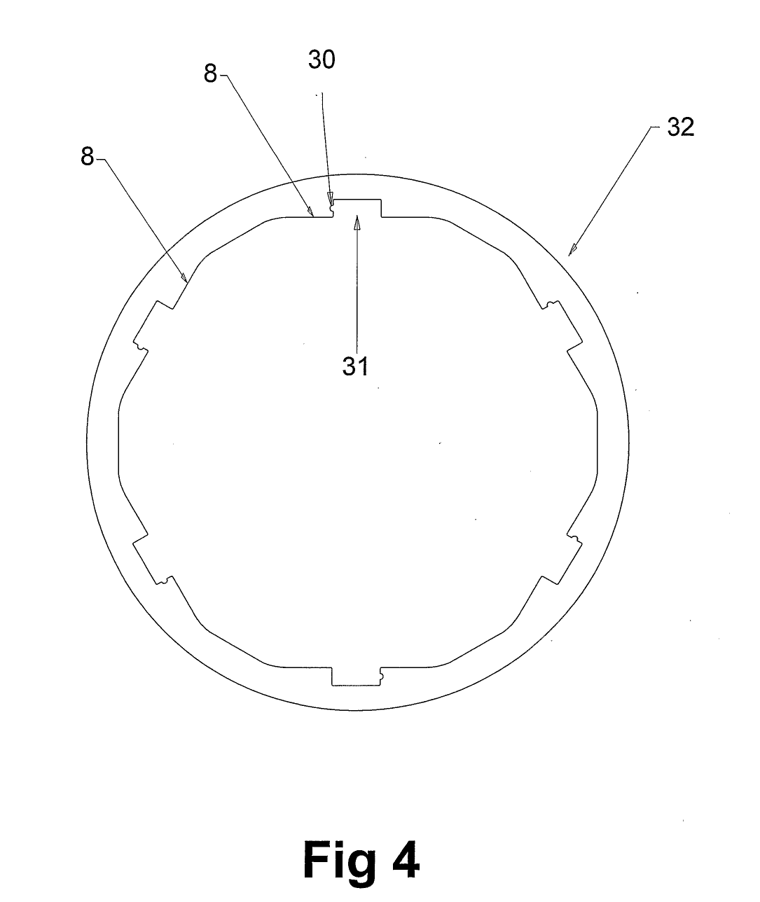

The stator 2 is constructed of a stack of laminations 32, one of which is illustrated in FIG. 4. These laminations are made of electrical steel, which has excellent magnetic and mechanical properties and very low electrical resistance. The laminated structure is required to avoid excessive eddy currents in the frame. Mechanically, the frame is very robust, so that the stator requires no other support or protection.

The pole pieces are made of a soft magnetic composite material, in this embodiment, this being bonded iron, which has is sold in Australia under the trade name “somaloy”. This material has appropriate magnetic properties to provide a core of the stator coils. It has a high electrical resistance, so it does not require lamination in order to avoid excessive eddy currents within the pole pieces.

The mechanical properties of somaloy are relatively poor. The pole pieces would shatter if struck forcefully. However, in use they are protected by the stator frame.

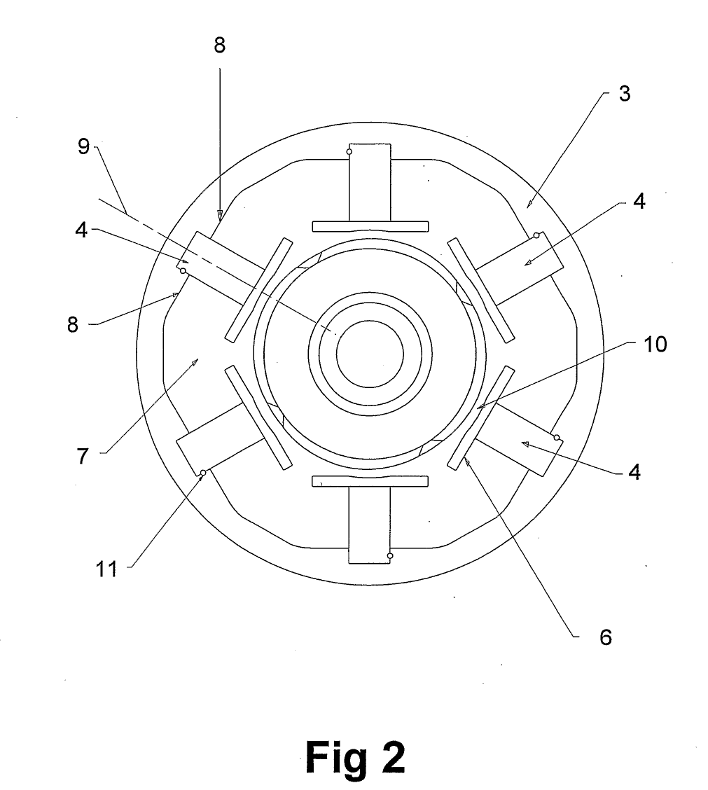

Referring to FIG. 2, which is a cross-section of the machine of FIG. 1, it is clear that the stator frame 3 supports pole pieces 4. These are held into the lamination stack which makes up the frame by a wire 11 which is force fit into a hole formed by matching semicircular grooves on the pole piece 4 and the stator frame 3. It will be understood that any other suitable fixing method, for example dovetails, fixing screws, semi-enclosed slots or adhesive means could be employed to hold the pole pieces in place.

It can be seen that the inner profile of the lamination stack frame includes a section 8 which is perpendicular to the axis 9 of the adjacent stator coil. This allows for a larger coil in closer contact with the stator than would be the case if the frame were made as a simple annular cylinder with a perfectly circular inner profile. Such an inner profile would be the only one possible if the frame were machined from a solid piece of isotropic material.

The flat step 8 can be clearly seen in FIG. 4, which shows a plan view of a single lamination of the frame.

The sections 8 serve, along with the sides of the stator pole pieces 4, serve to define a space 7 for the stator coils (not shown).

The faces 6 of the stator pole pieces 4 are shaped in order to reduce the air gap 10 between the rotor and the stator.

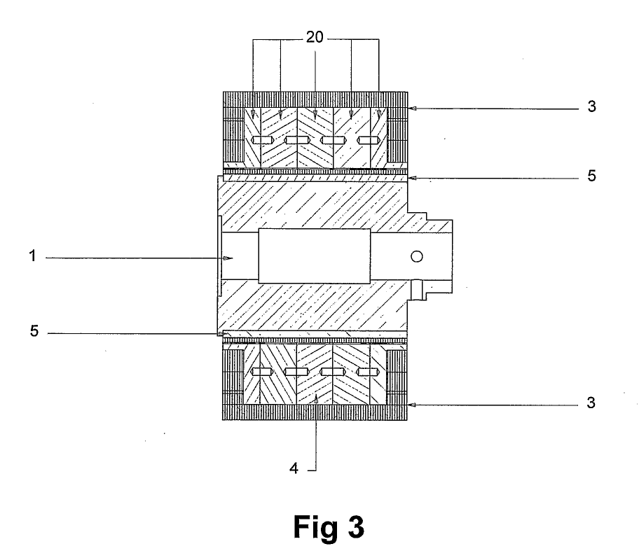

Referring to FIG. 3, which is a cross-section A-A of the machine of FIG. 2, it can be seen that the stator pole pieces are composed of individual elements 20 which are joined to form the stator pole piece 4.

Looking at FIG. 4, which is a plan view of a single lamination of the stator frame, it can be seen that the shape of the inner profile of the lamination is relatively complex. This is easily manufactured since the laminations are produced by stamping. The laminations are then stacked to form the stator frame. This allows the stator frame to have a much more complex inner profile than could be achieved by machining a solid block.

There is a recess 31 with a notch 30 which, when the laminations are stacked, form a slot with a semi-circular groove into which the stator pole pieces fit. The groove matches with a groove on the stator pole pieces to form the hole which receives wire 11 to hold the stator pole piece in place.

The purpose of this description is to describe the invention and not to limit this.

1. An electric machine including at least one magnetically inducible structure, said structure comprising at least two magnetically inducible portions, at least one said portion being of laminar construction and at least another said portion being non-laminar in construction, the laminar portion having greater mechanical strength than the non-laminar portion.

2. An electric machine as in claim 1, wherein the laminar portion is arranged to be in a location where its greater mechanical strength is effective to protect the less mechanically strong non-laminar portion.

3. An electric machine as in claim 1, wherein the non-laminar portion is positioned so that it is protected by the laminar portion, which is of greater mechanical strength.

4. An electric machine as in any one of claims 1, 2 or 3 wherein the magnetically inducible structure is a stator of the electric machine.

5. An electric machine as in claim 4, wherein the laminar portion is a frame of the stator of the electric machine.

6. An electric machine as in claim 4, wherein the non-laminar portion is at least one pole piece of the stator of the electric machine.

7. An electric machine as in claim 5, wherein the laminar portion is constructed from electrical steel.

8. An electric machine as in claim 6 wherein the laminar portion of the machine is constructed from bonded iron.

9. An electric machine as in claim 5 or claim 7 wherein each lamination of the frame is of such a shape that, when assembled into the frame, the internal profile of the frame is non-circular in such a way as to maximise the amount of space available for a stator coil.

10. An electric machine as in any one of the preceding claims wherein the electric machine is an electrical motor.

11. An electric machine as in any one of the preceding claims wherein the electric machine is an electrical generator.

12. An electric machine as in any one of the preceding claims wherein the electric machine is an electrical transformer.

13. An electric motor or generator having a stator and a rotor, characterised in that in at least the stator has at least one coil and a core that is magnetically inducible from said coil where the core has at least two parts where one of the parts is of laminar construction and provides a rugged support and a further part is of non laminar construction.

14. A electrical machine of the salient-pole type, wherein the stator of the electric machine comprises a frame supporting salient pole pieces,
characterised in that the frame is constructed from laminated electrical steel and the pole pieces are constructed from bonded iron.

15. A method of constructing an electric machine which includes the steps where approximately annular laminations are pressed from magnetically inducible, mechanically strong material,
said laminations are assembled into a frame,
and pole pieces made from a magnetically-inducible material of high electrical resistance are attached to said frame.

16. An electric machine substantially as described in the specification with reference to and as illustrated by any one or more of the accompanying drawings.
